(19) United States
(12) Patent Application Publication
(10) Pub. No.: US 2003/0063687 A1
(43) Pub. Date: Apr. 3, 2003

(54) Linear motor

(76) Inventor: Yong-Yil Kim, Seoul (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/968,468

(22) Filed: Sep. 29, 2001

(51) Int. Cl. H04K 1/02

(52) U.S. Cl. 375/297

(57) ABSTRACT

A multi-phase coil assembly includes a first coil having first top and bottom arms on a first plane and a first coil central portion including left and right arms on a second plane; a second coil having second top and bottom arms on the first plane and a second coil central portion including left and right arms on the second plane, the second coil left arm being positioned adjacent the first coil right arm; and a third coil having third top and bottom arms on a third plane and a third coil central portion including left and right arms on the second plane and positioned between the first coil right arm and the second coil left arm, the third top arm engaging the first and second top arms and the third bottom arm engaging the first and second bottom arms; the first, second and third coils being arranged for movement with the central portions on the second plane having a thickness equivalent to a thickness of a single coil and the top and bottom arms each when engaged having a constant thickness of about twice the thickness.

### BACKGROUND

This invention relates to a linear motor.

Linear motors offer many advantages, such as very high acceleration (up to 10 g) and sub-micron positioning accuracy, and can be ideal for new machinery or upgrades. Other benefits include having only one moving part, which leads to simplicity and reliability, with no backlash and high stiffness. Non-contact operation also reduces wear, giving long life and a reduction in maintenance. Linear motors are used in a variety of applications. For example, they are used in semiconductor manufacturing equipment, factory automation machinery, micro-lithographic instruments, and in other precision motion devices for precisely controlling the position of devices and instruments.

A conventional synchronous linear motor includes a magnet array that electromagnetically interacts with a coil array. Electromagnetic forces (called Lorentz forces) are generated on the coil array in cooperation with the magnet array, and the electromagnetic forces on the coil array cause the coil array to be propelled with respect to the magnet array, or vice versa. Thus, linear motors may incorporate a stationary magnet array (where the coil array is propelled) or a stationary coil array (where the magnet array is propelled). The coil array is typically mechanically secured to a translation stage (or carriage) that is slideably engaged with a set of rails.

Typically, a conventional moving coil type linear motor provides permanent magnets on both sides of a moveable coil assembly. The magnets are fixed on the inside surfaces of two rails so that they side each other. The magnets are mounted next to each other, each successive magnet having a pole orientation opposite that of the prior magnet.

The coil assembly is made of several coils potted into an epoxy plate. Each coil includes a wire that is wound around a generally rectangular frame with an opening in the center of the frame. The wire is wound in a direction perpendicular to the magnetic fluxes of the magnetic field created by the permanent magnets. A series of coils are placed adjacent each other and between the two opposing permanent magnet arrays. The wires wound on the coils intersect the flux lines between the opposing permanent magnet arrays, and an application of electricity to the wires creates a Lorentz force to move the coils.

To increase the power of the motor, the area on the coil frames needs to be increased so that more magnetic flux can pass though the coils. To increase the area on the frame for passing magnetic flux, the coils can be “stacked” to take advantage of the inactive spaces in the center of the coils. In such an arrangement, one side of the coil frame can be placed in the opening of another coil frame. FIG. 1 shows one such arrangement. As shown therein, five rectangular coils 22, 24, 26, 28, and 30 are stacked relative to each other. The coil 22 has two horizontal sides 22a and 22b, two longitudinal sides 22c and 22d and an opening 22o. Similarly, the coil 24 has two horizontal sides 24a and 24b and two longitudinal sides 24c and 24d. The side 24c is placed in the opening 22o of the coil 22 to capture the magnetic flux that flows through the opening 22o.

For a three-phase motor, typically three coils are placed next to each other in series. Three phase power has three “hot” wires, 120 degrees out of phase with each other. The three phase power is cost effective, efficient and provides a high starting torque. For each phase, a coil is used, and thus for a three-phase motor, three coils are used as a set and they can be stacked. FIG. 2 shows a side view of the stacked coils for three phase power. As can seen, the thickness or height of the assembly of coils 22 and 24 can be three times the thickness of each individual coil due to the stacking of three coils at certain locations. The thickness varies, and one thickness sequence is 1 d, 2 d, 3 d, 2 d, 1 d, where d is the thickness of one coil. The 3 d thickness is not desirable for manufacturing, since 3 d is so thick that the coils need to be strongly bent at certain locations, and such force can break and/or reduce the structural integrity of the coils. Moreover, the variation in thickness (d, 2 d, 3 d, 2 d, d thickness sequence) is undesirable.

U.S. Pat. No. 4,314,295 to Frandsen discloses an array of flat-coil actuators, with each actuator comprising a number of flat-coil turns on at least one side of a planar substrate, this substrate being arranged to run between opposing magnet pole pieces along a path defined by a pair of opposed runways, with these coils being disposed in “overlapping” relation relative to one another and to respective pole pieces—thus when selected coil turns are energized the substrate may be controllably translated and positioned.

U.S. Pat. No. 4,390,827 to Imahashi shows a two-phase linear motor making use of a D.C. current and in which magnetic fields having alternately reversing directions of magnetic paths are formed at equal intervals along a straight line. In Imahashi, one set of two coils is placed in this magnetic field as positioned in such manner that when one of the coils crosses the lines of magnetic force to a maximum extent, the other coil may cross the lines of magnetic force to a minimum extent. A large number of permanent magnet pairs are arrayed and the directions of the magnetic field produced by these permanent magnet pairs are alternately reversed. Two coils are disposed as staggered by a half pitch from each other. The portions of the coils to be placed within the magnetic fields are wound in a flat shape, and the width of the windings of the coils and the width of the space inside of the coil are made approximately equal to each other. In one coil pair, the coils are disposed in such configuration that a coil side of one coil may be fitted in the inside space of the other coil, and in another example of the coil pair, two coils could be simply disposed side by side and fixed to each other

U.S. Pat. No. 4,758,750 to Itagaki, et al.discloses a linear motor of moving-coil type in which a multi-phase moving coil includes a plurality of coil units each not wider than the longitudinal length of a permanent magnet making up a stationary part divided by the number of coil phases, the coil units being arranged successively in the same plane with central parts not adjacently overlaid one on the other. The central parts of the moving coil units have a thickness equivalent to a single phase in spite of the multiple phases of the moving coil. In Itagaki, the moving coil includes three coil units wound within the width one-third the width of the permanent magnet in a plane parallel to the page. The coil units are displaced from the coil unit and therefore the central parts of the coil units are not laid one on another, so that the central part of the moving coil remains in a thickness equivalent to one phase. The upper and lower ends not in opposed relations with the magnets have such an ample space around them that they may be formed in various shapes. The upper and lower ends shown and can have a thickness equivalent to one phase, two phases and three phases respectively. Due to the stacking, the central portion of the moving coil can have a thickness between one and three times the thickness of the coil.

U.S. Pat. No. 4,839,543 to Beakley, et al. shows a moving coil linear motor having a central row of alternating, permanent magnets, with multi-phase, multi-pole coil assemblies located on both sides of the magnet row. Magnetic circuit completion material is located approximately the same height as the magnets and outside the coil assemblies. The coil assemblies are formed of a series of individual coils connected in a multi-phase, multi-pole relationship. At locations other than the coil assembly ends, the individual coils of a phase are adjacent and connected so that a current passes through them in a uniform direction. The individual coil total width is equal to the distance from a point on a magnet to the same point on the adjacent magnet, with the individual coil thickness being the total width divided by twice the number of phases.

To further increase the power of the motor, two motor sub-units can be stacked. FIG. 3 shows one such motor 50 with a first motor sub-unit 60 mounted above a second motor sub-unit 70. The motor sub-unit includes a yoke 61 having top and bottom portions 61a and 61b. Mounted on each of top and bottom portions 61a and 61b is a permanent magnet array 63a or 63b with magnet strips having ends placed in an alternating north/south pole configuration. An elongated coil 65 is positioned between the magnet arrays 63a and 63b. Similarly, the motor sub-unit 70 includes a yoke 71 having top and bottom portions 71a and 71b. Mounted on each of top and bottom portions 71a and 71b is a permanent magnet array 73a or 73b with magnet strips having ends placed in an alternating north/south pole configuration. An elongated coil 75 is positioned between the magnet arrays 73a and 73b. When currents are applied to the coils 65 and 75, a Lorentz force is generated and drives a stage that is secured to both coils 65 and 75. As shown in FIG. 3, magnetic flux lines 67 and 77 have separate flux return paths for each of motor sub-units 60 and 70. Although the magnetic flux lines 67 and 77 flow in the same direction and thus are additive in FIG. 3, they can also flow in opposite directions (or subtractive). Also, due to the stacking, a distance 69 (which equals the thicknesses of portions 61b and 71a) separates the magnet arrays 63b and 73a. The flux path is lengthened due to 1) the presence of the motor casings for motors 60 and 70 increases the distance 69, and 2) the separate flux return paths.

### SUMMARY

In one aspect, a multi-phase coil assembly includes a first coil having first top and bottom arms on a first plane and a first coil central portion including left and right arms on a second plane; a second coil having second top and bottom arms on the first plane and a second coil central portion including left and right arms on the second plane, the second coil left arm being positioned adjacent the first coil right arm; and a third coil having third top and bottom arms on a third plane and a third coil central portion including left and right arms on the second plane and positioned between the first coil right arm and the second coil left arm, the third top arm engaging the first and second top arms and the third bottom arm engaging the first and second bottom arms; the first, second and third coils being arranged for movement with the central portions on the second plane having a thickness equivalent to a thickness of a single coil and the top and bottom arms each when engaged having a constant thickness of about twice the thickness.

Implementations of the above aspect may include one or more of the following. Each of the coils is gull-wing shaped. Further, each of the coils can be doubly folded. The coil can have a forty-five degree bend connecting each the left and right arms to each the top and bottom arms. The first plane is spaced from the second plane by one-half the thickness. The coils can be arranged for movement in a gap in the longitudinal direction of a magnetic field. Additional coils can be added to the assembly, with adjacent coils having a thickness equivalent to the thickness. Thus, a fourth coil can be added having fourth top and bottom arms on the first plane and a fourth coil central portion including left and right arms on the second plane. A fifth coil can be added having second top and bottom arms on the second plane and a fifth coil central portion including left and right arms on the second plane, the fifth coil left arm being positioned adjacent the third coil right arm. The first, second, third, fourth and fifth coils can move with the central portions having a thickness equivalent to a thickness of a single coil and the top and bottom arms each when engaged having a thickness equivalent to twice the thickness. A yoke can be used, the yoke having a first slot to receive the coil assembly and a second slot capable of receiving a second coil assembly. Each slot includes two opposing faces, wherein each opposing face further includes a plurality of magnets aligned in a row forming a magnet plane and having a longitudinal axis, the magnets aligned with alternating pole orientations on the faces of the magnet plane.

In another aspect, a linear motor yoke assembly includes first and second coil assemblies, each coil assembly formed from a plurality of coils; and a housing with two substantially elongated slots adapted to receive the first and second coil assemblies, wherein each elongated slot includes two opposing faces, wherein each opposing face including a plurality of magnets aligned in a row and having a longitudinal axis, the magnets aligned with alternating pole orientations on the faces of the magnet plane.

Implementations of the linear motor yoke assembly can include one or more of the following. A magnetic flux line can exist on the yoke that traverses the magnets on the first and second slots in a single loop. Each coil assembly can include a first coil having first top and bottom arms on a first plane and a first coil central portion including left and right arms on at second plane; a second coil having second top and bottom arms on the first plane and a second coil central portion including left and right arms on the second plane, the second coil left arm being positioned adjacent the first coil right arm; and a third coil having third top and bottom arms on a third plane and a third coil central portion including left and right arms on the second plane and positioned between the first coil right arm and the second coil left arm, the third top arm engaging the first and second top arms and the third bottom arm engaging the first and second bottom arms; the first, second and third coils being arranged for movement with the central portions on the second plane having a thickness equivalent to a thickness of a single coil and the top and bottom arms each when engaged having a constant thickness of about twice the thickness. The two slots can include eight magnets mounted on the faces of the two slots, wherein the magnetic flux path traverses through eight magnets in the single loop. The housing can be M-shaped. Each coil assembly includes a central portion with a thickness equivalent to a thickness of a single coil, each coil assembly having top and bottom portions having a thickness equivalent to twice the thickness.

In yet another aspect, a linear motor includes first and second coil assemblies, each coil assembly including: a first coil having first top and bottom arms on a first plane and a first coil central portion including left and right arms on a second plane; a second coil having second top and bottom arms on the first plane and a second coil central portion including left and right arms on the second plane, the second coil left arm being positioned adjacent the first coil right arm ; and a third coil having third top and bottom arms on a third plane and a third coil central portion including left and right arms on the second plane and positioned between the first coil right arm and the second coil left arm, the third top arm engaging the first and second top arms and the third bottom arm engaging the first and second bottom arms; the first, second and third coils being arranged for movement with the central portions on the second plane having a thickness equivalent to a thickness of a single coil and the top and bottom arms each when engaged having a constant thickness of about twice the thickness; and a housing with two substantially elongated slots adapted to receive the first and second coil assemblies, wherein each elongated slot includes two opposing faces, wherein each opposing face including a plurality of magnets aligned in a row and having a longitudinal axis, the magnets aligned with alternating pole orientations on the faces of the magnet plane.

Advantages of the system may include one or more of the following. The stacked coil combination achieves a high magnetic flux density while minimizing its profile or dimensions. The stacked coil combination achieves a thickness of one coil in the center region and a thickness of two coils at the ends of the coil combinations. The thickness at each end of the coil is constantly twice the coil thickness, regardless of the number of coils stacked. This is better than the prior art stacking techniques which have varying end thicknesses (such as 1 d, 2 d, 3 d, 2 d, and 1 d, where d is the thickness of the coil), depending on the stack position. The coil's double folding is also advantageous, as it allows the coils to be bent at a slight angle rather than a steep angle. Such bending reduces stress on the coils and thus contributes to overall reliability.

Further, the high flux density is achieved without requiring expensive core materials such as steel alloys having a high magnetic saturation level and a high magnetic permeability in order to permit the production of an equivalent high magnetic flux density. Thus, the stacked coil combination synergistically supports a powerful linear motor is achieved that is cost-effective and has a low profile.

The coil combination of the linear motor is thin and compact. A thinner coil winding structure increases the motor force constant and to reduces the carriage weight. An increase in the motor force constant and the reduced weight of the carriage enhance performance and increase the possible acceleration. With three-phase commutation, the increased force exerted by the linear motor is still relatively constant throughout the length of the motor.

When the stacked coil combination is used with the integrated dual motor sub-units, the synergistic effects are amplified even more. In the integrated dual motor sub-units, magnetic flux lines flow through the entire yoke, entering and leaving the upper and lower edges of the yoke and flowing through all magnet arrays. This is in contrast to conventional linear motors where the flux lines enters and leaves opposing magnet arrays as one flux line set and enters and leaves opposing magnet arrays as another flux line set. Thus, to illustrate, magnetic flux flows through eight magnets rather than through four magnets as is done in conventional linear motors.

The yoke design allows the opposing magnet arrays to be moved close to each other to reduce magnetic flux path. Magnetic flux path is further reduced due to the elimination of one flux path when the motor is stacked in accordance with the invention. The reduced distance increases flux density to support a powerful linear motor. The reduced distance also allows thin magnets to be used due to the path shape.

The integrated dual motor sub-unit design offers high magnetic density that supports a high power linear motor. The resulting linear motor is thin and offers a compact configuration Further, the yoke and coil combination offers a high magnetic flux density and produces large forces for the linear motor. As an additional benefit, the dimensions of the motor allow the linear motor to be used in applications with size constraints. For applications that desire additional power, the motor can be scaled to stack more than two motors. In such cases, the magnets needed can be even thinner than the magnets of the dual motor subunits discussed above. The motor is also efficient and low in operating cost. It also is highly responsive to the demands of the application.

Other advantages and features will become apparent from the following description, including the drawings and claims.

### BRIEF DESCRIPTION OF THE DRAWINGS

FIG. 1 shows a prior art stacked coil arrangement.

FIG. 2 shows a cross sectional view of the coil arrangement of FIG. 1.

FIG. 3 shows a prior art stacked motor with two motor sub-units.

FIGS. 4A, 4B and 4C show a perspective view, a cross-sectional view, and an enlarged view of a section of a linear motor, respectively.

FIG. 5 shows a perspective view of a motor yoke.

FIG. 6 shows exemplary magnetic flux lines flowing through the yoke of FIG. 5.

FIGS. 7 and 8 show a perspective view and a cross sectional view of one embodiment of a coil assembly.

FIG. 9 shows a cross section of wires in the coils of FIGS. 7-8.

FIG. 10 shows a cross-sectional view of a simplified motor.

FIG. 11 shows the magnetic flux in the motor of FIG. 10.

FIG. 12 shows movement sequences for the motor of FIG. 10.

FIG. 13 shows one embodiment of a linear motor using a second coil assembly embodiment.

FIG. 14 shows a cross section of the coil assembly embodiment of FIG. 13.

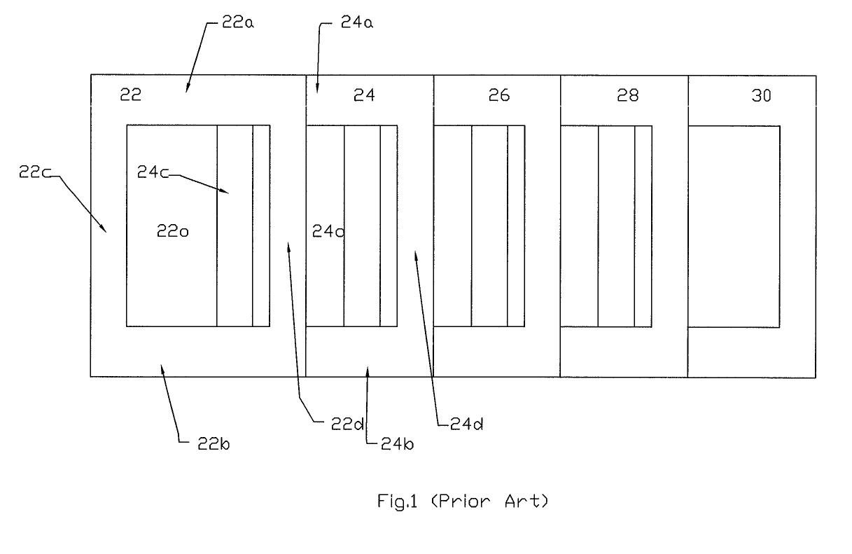

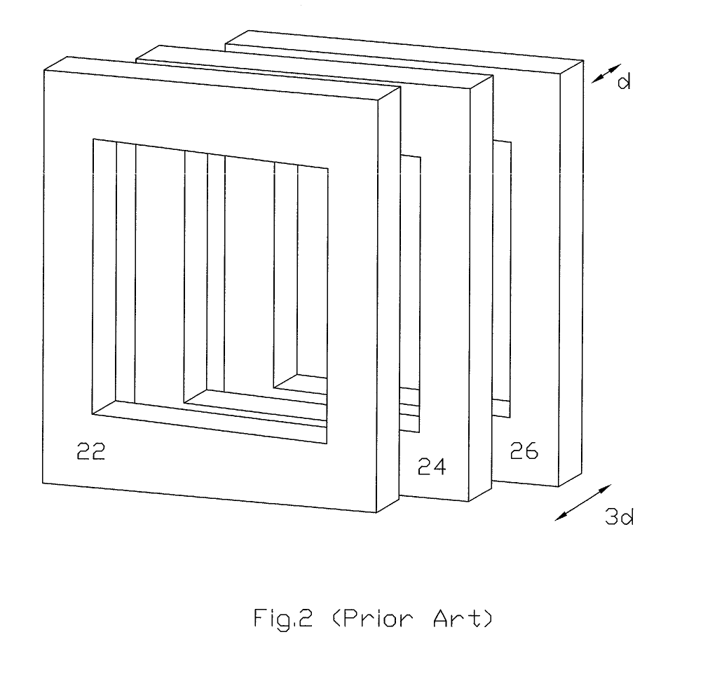

### DESCRIPTION

Referring now to the drawings in greater detail, there is illustrated therein structure diagrams for a linear motor. It will be understood that the motor's enhanced power is achieved through a coil assembly that stacks a number of coils in a configuration whose thickness is one coil thickness at the point where the coil assembly interacts with permanent magnet arrays. The power's power is also enhanced by stacking motor sub-units in an integrated yoke, as will be more readily understood from a study of the diagrams.

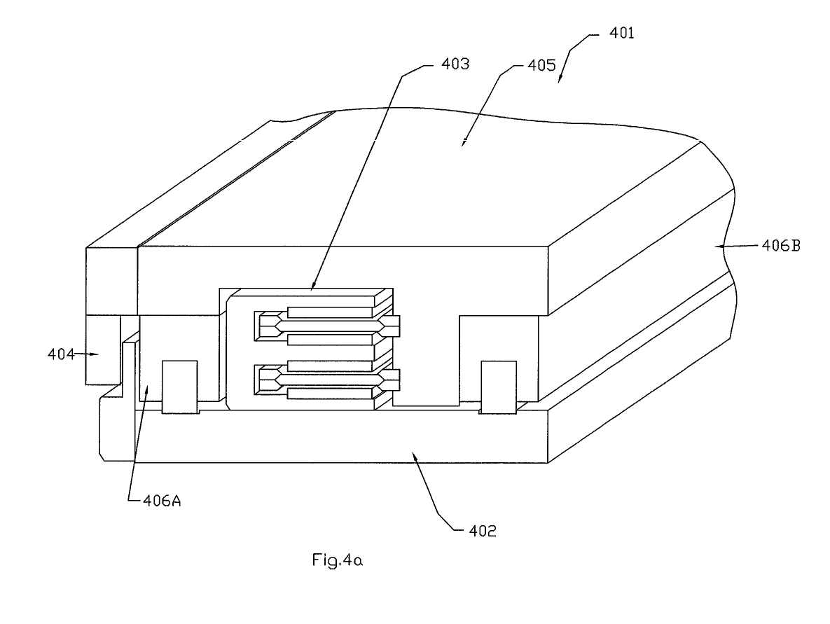

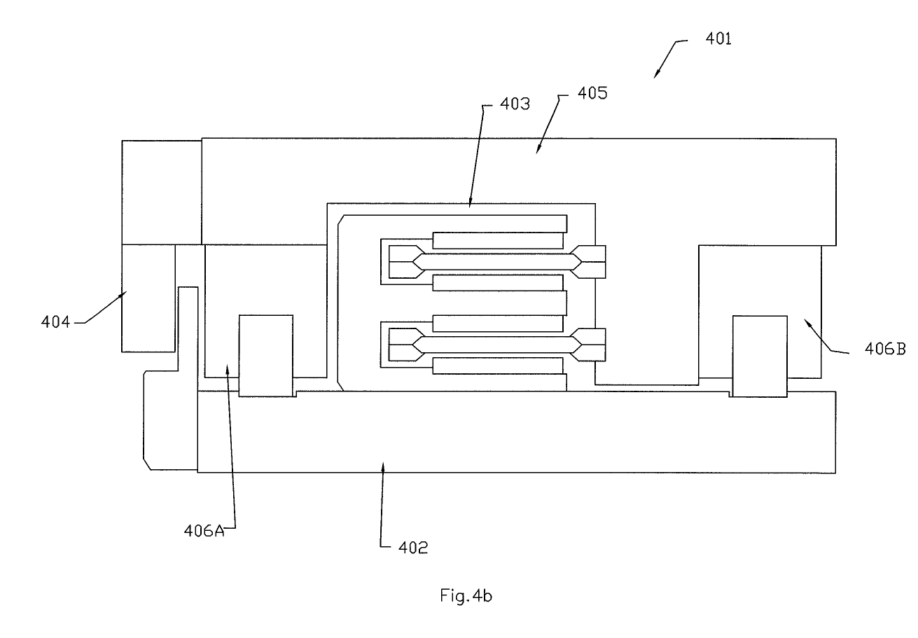

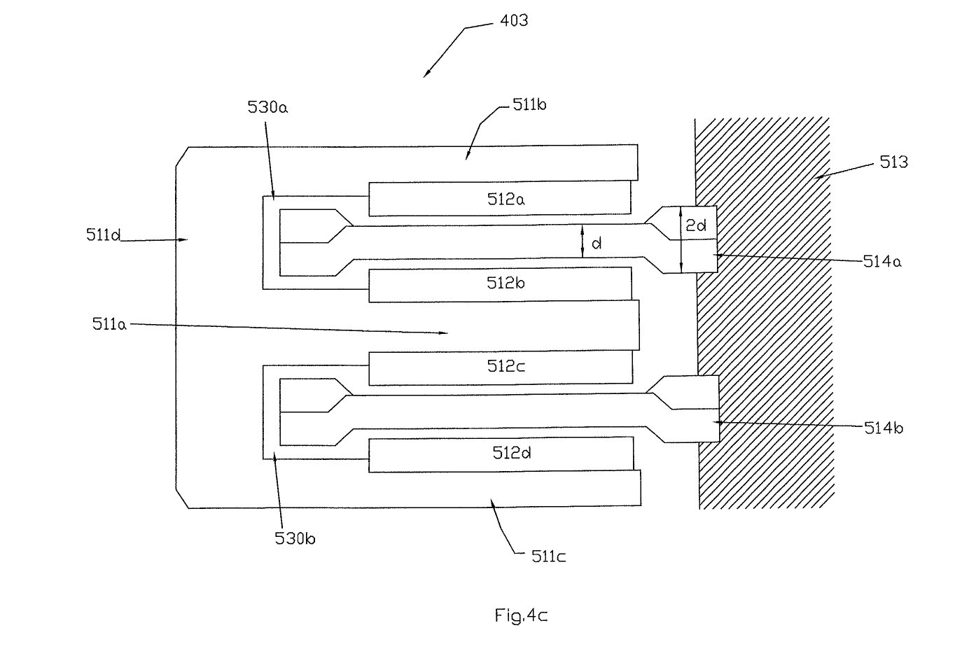

FIGS. 4A, 4B and 4C show a perspective view, a cross-sectional view, and an enlarged view of a section of a linear motor 401, respectively. The linear motor 401 has two elongated bearings 406A and 406B that act as rails for the linear motor 401. The bearings 406A and 406B rest above an elongated base plate 402. The bearings 406A-406B are sliding bearings that allow a load such as a carriage or stage to traverse a distance using the linear motor 401.

An actuator assembly 403 is positioned above the base plate 402 and between the bearings 406A and 406B. The actuator assembly 403 is described in more detail below in FIGS. 4C, 5 and 6. A top plate 405 is positioned on top of the bearings 406A-406B and the linear actuator 403. The top plate 405 has a downward projection or tab that, in tandem with the linear actuator 403, secures the actuator 403 to the rest of the motor 401. A position encoder 404 is mounted on the top plate 405 and positioned between the top plate 405 and the base plate 402. The encoder 404 senses the current position of the linear motor 401. Various types of position sensors can be used, including optical position sensor, resistive (potentiometric) position sensor, and magnetic position sensor (inductosyn). In an optical sensor, a movable code plate is made from a glass plate onto which chrome has been vapor deposited, or a metal plate, such as stainless steel, nickel, copper, or the like, and light transmitting sections are formed by etching in portions of ring-shaped regions scanned by a light-emitting element (LED) of a light source. The light source and a light receiving section are provided on either side of the movable code plate. The light source 1 and light receiving section are constituted respectively by a prescribed number of light-emitting elements (omitted from drawing) and photoreceptor elements. When a light transmitting section is positioned in front of the photoreceptor elements, light projected from the light source to the movable code plate is transmitted by the light transmitting section and enters the corresponding photoreceptor element, and a signal representing the received light is output by the photoreceptor element. A potentiometric sensor is essentially a voltage divider having a sliding contact which engages a carbon film strip or other electrically resistive means that is electrically connected to a supply voltage. The output voltage from the sensor is the voltage on the sliding contact or a proportion thereof. The position affects the position of the sliding contact relative to the resistive means, and so the value of the output voltage from the sensor can be used to provide an indication of the detected or measured position. The magnetic position sensor employs a plurality of square wave windings mounted on the surface of a stationary element, and a coil connected to an AC power source mounted on a movable element. The square wave windings each comprise a plurality of “high” and “low” parts and have different periods. The system determines the position of the movable element relative to the stationary element by detecting the variation in mutual inductance between the coil and the plurality of square wave windings. When the power source energizes the coil, a large current is induced in a square wave winding if the coil is adjacent a high part thereof. Only a small current is induced in a winding if the coil is adjacent a low part thereof. Therefore, the position of the movable element along the length of the stationary element can be determined from the signals on the windings.

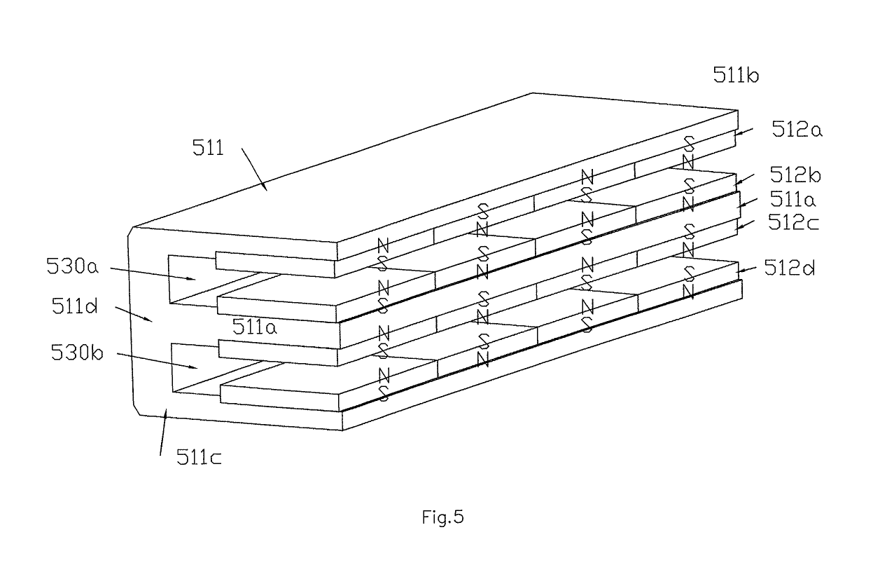

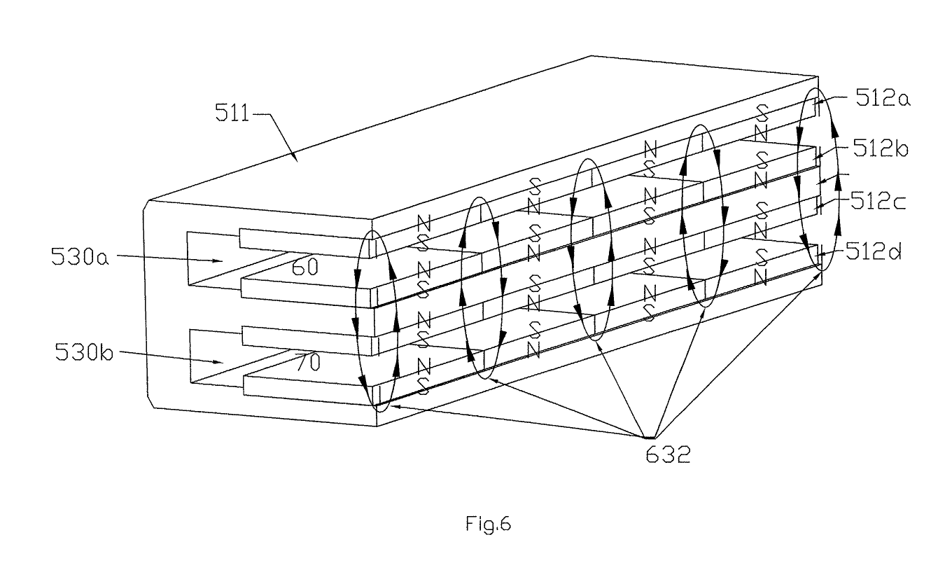

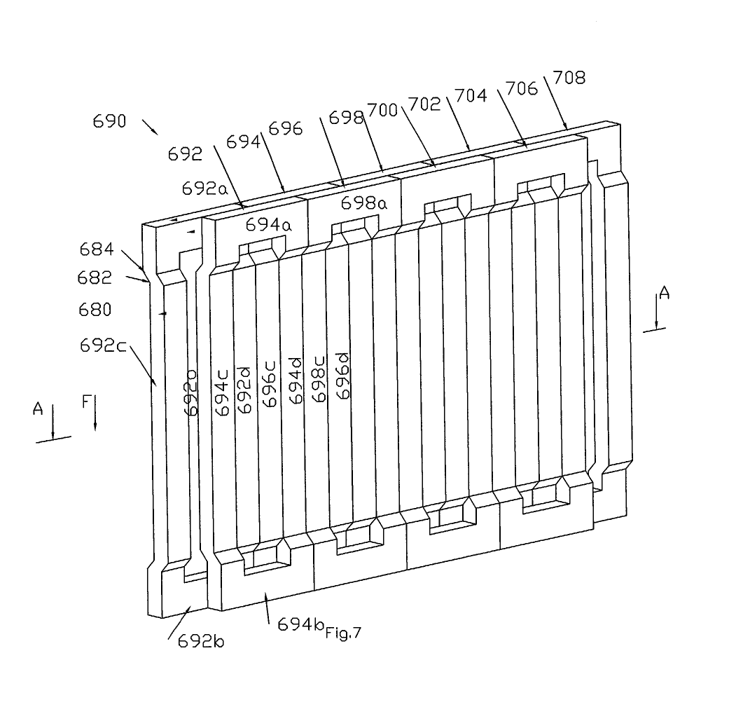

FIG. 4C shows in more detail the actuator assembly 403. The actuator assembly 403 includes a yoke 511 having three forks or portions 511b, 511a and 511c defining two cavities 530 and 532. The three forks or portions 511b, 511a and 511c are joined at one end by a common portion 511d, and the portions 511a-511d define two cavities 530a and 530b. Mounted on each face (upper and lower) of the cavities 530a and 530b is a permanent magnet array 512a, 512b, 512c or 512d of magnet strips having ends placed in an alternating north/south pole configuration. Substantially elongated coils 514a and 514b are positioned in the cavities 530a and 530b. The coils 514a and 514b are wound in a direction perpendicular to the magnetic fluxes of the magnetic field created by the permanent magnets. When currents are applied to the coil array, a Lorentz force is generated and drives a stage in the assembly 403 to move. The yoke 511 is described in more detail in FIGS. 5-6, while an exemplary coil such as the coil 514a is detailed in FIG. 7.

FIG. 5 shows a perspective view of the yoke 511. The yoke 511 may be composed of a material having a high magnetic permeability and saturation level such as permalloy or supermalloy. A permanent magnet array 512a is mounted on the inside surface (i.e., towards the center of the cavity 530a) of the upper yoke 511b and a permanent magnet array 512b is mounted to the inside surface of the upper middle yoke 511d. Correspondingly, a permanent magnet array 512c is mounted on the inside surface (i.e., towards the center of the cavity 530b) of the middle yoke 511d and a permanent magnet array 512d is mounted to the inside surface of the lower middle yoke 511c. The permanent magnet arrays 512a, 512b, 512c and 512d include any number of permanent magnet strips, and alternating permanent magnet strips are arranged to have alternating polarities. For example, the permanent magnet array 512a has strips whose poles at the end portion 511a have alternating south pole/north poles directed towards the permanent magnet array 512b while the permanent magnet array 512b have corresponding strips with corresponding alternating north poles/south poles directed towards the inside of the cavity.

The strips 512a-512d are permanently magnetized strips magnetized in the direction of the thickness of the strip. The width of a permanent magnet strip refers to the dimension of the permanent magnet strip along the direction of motion of the motor. In one embodiment, each of the magnetic strips in the permanent magnet strips have substantially the same width. The permanent magnet strips can be formed from any permanent magnet material, such as neodymium iron boron (NdFeB). The permanent magnet strips can be attached to the upper yoke 511b, the lower yoke 511c and the middle yoke 511a, respectively, in any fashion, including glue or epoxy. Additional mechanisms for attaching permanent magnet strips to the yoke portions 511a, 511b, and 511c, respectively, include mechanical clamping and magnetic attraction. The magnets arrays are of uniform thickness so that their surfaces are a constant distance above surfaces of coil assemblies of an armature assembly (not shown). The magnets are designed to produce, along an axis of movement, a generally sinusoidal flux distribution for interaction with fields produced by the coil assemblies.

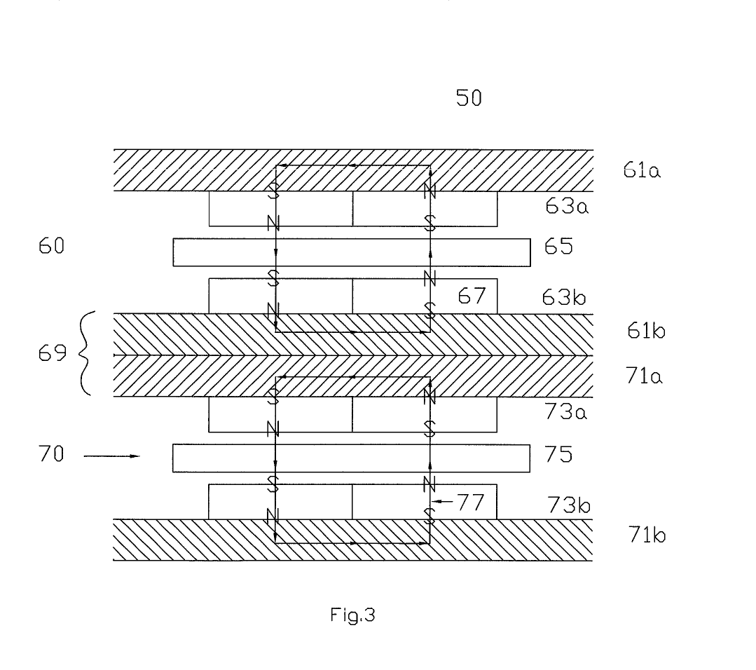

The structure of FIG. 5 is advantageous over the prior art shown if FIG. 3 that simply stacks two sub-motor housings together. First, the stacked motors of FIG. 3 are thick and have two separate flux loops. When the thickness of the stacked motor housings of the prior art is reduced, the opposing magnets would be attracted to each other and would distort the shape of the housings. In contrast, the structure of FIG. 5 experiences counteracting magnetic forces of the four magnet arrays and does not face such distortion. The middle fork 511a thus can be made thinner than the separate motor housings 61b and 71a of FIG. 3. Further, due to the reduced flux path, the magnet arrays 512a-512d can be made thinner as well.

FIG. 6 shows exemplary magnetic flux lines 632 flowing through the yoke 511. As shown therein, a plurality of flux lines 632 pass longitudinally through the yoke 511, entering and leaving the upper and lower edges of the entire yoke 511 and flowing through all magnet arrays 512a, 512b, 512c and 512d (FIG. 5). The single flux line across all magnets of the two sub-motors 60 and 70 reduces the flux path. The flux path is further reduced by eliminating the housing of conventional sub-motors. This is in contrast to conventional linear motors with lengthened flux path due to the stacking of the motor housing and also due to the multiple flux line set. By reducing flux path, flux strength is increased, resulting in a powerful motor.

The yoke of FIGS. 5-6 is thin and offers a compact configuration. Further, the yoke and coil combination offers a high magnetic flux density and produces large forces for the linear motor. Moreover, although the yoke 511 has only two sub-motors or stages 60 and 70, any arbitrary number of N motors can be stacked to increase motor power. In such stacking of N sub-motors, the thickness of the magnets can be reduced since the flux path shape is shortened.

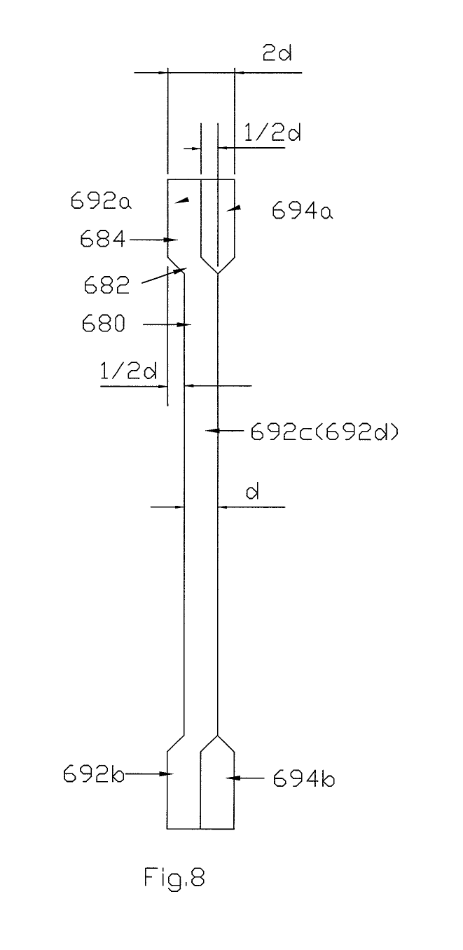

FIGS. 7 and 8 show a perspective view and a cross sectional view of one embodiment of a coil assembly 690 containing coils 692-708. Since the coil structure is identical, only representative coils 692-698 and their relationships are discussed in depth.

The coil 692 includes a generally rectangular monolithic body having a top arm 692a, a bottom arm 692b, and left and right arms 692c and 692d, respectively. Together, the arm 692a-692d define an opening 692o. In one embodiment, the top and bottom arms 692a and 692b are shorter than the elongated arms 692c and 692d. However, the arms 692a-692d can be symmetrical or non symmetrical and can take any shape. The top and bottom arms 692a-692b are positioned on a different plane relative to plane of the left and right arms 692c and 692d.

Due to the differential elevation of the arms 692c and 692d, when viewed from the arm with the arms 692c and 692d on the bottom and the arms 692a and 692b on top, the coil 692 is gull-wing shaped with two folds in the coil: one fold occurs when the coil 692 transitions from spot 680 to spot 682 and a second fold occurs when the coil 692 transitions from spot 682 to spot 684. The two-fold structure is advantageous in that the coils only need to be bent at a small angle. Such gradual bending minimizes mechanical stress on the coil during fabrication and preserves coil strength and subsequently results in a more robust and reliable linear motor.

Similarly, the coil 694 includes a generally rectangular monolithic body having a top arm 694a, a bottom arm 694b, and a pair of opposing left and right arms 694c and 694d, respectively. Together, the arms 694a-694d define an opening 694o. The arms 694a and 694b are shorter than the arms 694c and 694d and are elevated relative to the elongated arms 694c and 694d. Similarly, the coil 696 includes a generally rectangular monolithic body having a top arm 696a, a bottom arm 696b, and a pair of opposing left and right arms 696c and 696d, respectively. Together, the arms 696a-696d define an opening 696o.

A right portion of the opening 692o receives the arm 694c, while the left portion of the opening 692o would have received a right arm of a coil positioned to the left of the coil 692 (not shown). Correspondingly, the arm 694d is positioned in the left portion of the opening 696o while the arm 69c occupies the right portion of the opening 696o. This sequence is continued along the length of the coil assembly.

The gull-wing shape of the coils 692-694 allows two coils to be stacked together and yet still have the thickness of only one coil at the central openings 692o, 694o and 696o, as illustrated in FIG. 8. For this embodiment, the coil is bent ½ d at a forty five degree angle between points 680 and 684. As shown therein, the coil thickness at the opening 692o is d. The thickness d is the distance between the magnetic arrays 512a and 592b.

The multi-phase coil assembly of FIG. 8 includes the first coil 692 having first top and bottom arms 692a and 692b on a first plane extending between the center of the arms 692a and 692b and a first coil central portion including left and right arms 692c and 692d on a second plane extending between the center of left and right arms 692c and 692d. The assembly also includes a second coil (not shown in FIG. 8) having second top and bottom arms 696a and 694b on the first plane and a second coil central portion including left and right arms on the second plane, the second coil left arm being positioned adjacent the first coil right arm. The assembly of FIG. 8 also includes a third coil 694 having third top and bottom arms 694a and 694b on a third plane extending between the center of arms 694a and 694b and a third coil central portion including left and right arms on the second plane and positioned between the first coil right arm and the second coil left arm, the third top arm engaging the first and second top arms and the third bottom arm engaging the first and second bottom arms. In FIG. 8, the first, second and third coils are arranged for movement with the central portions on the second plane having a thickness equivalent to a thickness d of a single coil and the top and bottom arms each when engaged having a constant thickness of about twice the thickness 2 d.

In comparison, prior art coils, when stacked, can have thickness between 2 and 3 times the thickness of one coil. This thinness is achieved while doubling the area for capturing magnetic flux from the opposing magnet arrays. Due to the thinness of the coil, magnetic flux is increased while magnetic path is reduce, both of which synergistically increases the power of the linear motor.

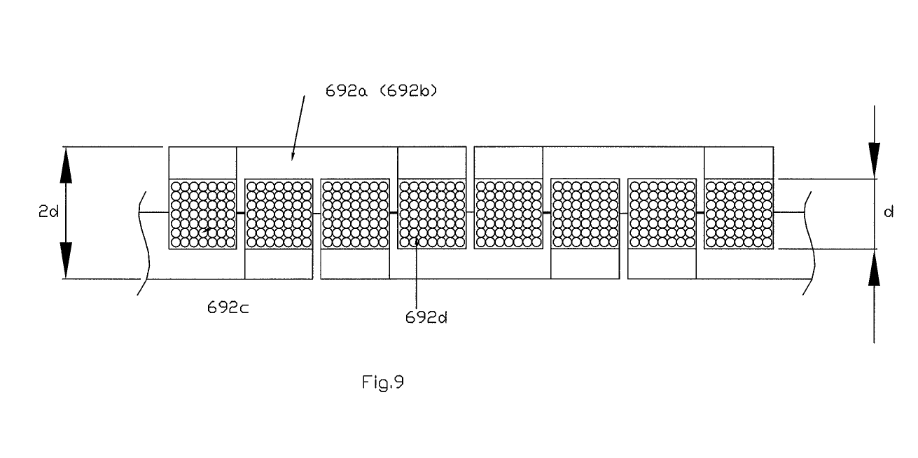

A cross section of wires in the coils 670-698 is shown in FIG. 9, and as shown therein, the wires for the coils 692-708 are arranged in a planar sequence with a unitary width d. A winding of a plurality of layers each of which consists of turns of an electrically conducting material in wire form, with a polymer material which electrically insulates the individual turns of the wire-form material from one another. The individual windings of the coil are enveloped with the aid of a curable epoxy resin composition. In one embodiment, this composition is thermally cured with suitable curable compositions for carrying out the impregnation. The cross section of the exemplary array of coils 690 contains an array of eight coils are positioned in a planar manner, each of the coils in turn have a square cross section with a winding array of 7×7 wires.

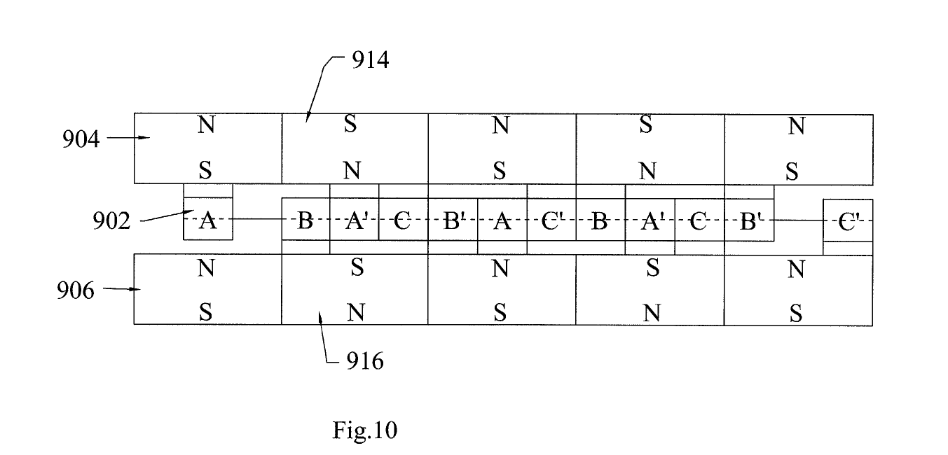

FIGS. 10-12 illustrate the operation of a simplified motor 900. Turning now to FIG. 10, a cross-sectional view of a simplified motor 900 is shown. The motor 900 has a coil assembly 902 positioned between opposing magnet arrays 904-906 and with opposing magnetic polarities. Thus, for example, a magnet 914 in the magnet array 904 is positioned directly across a magnet 916 in the magnet array 906. Further, the magnet 914 has a north magnetic polarity, while the magnet 916 has a south magnetic polarity. Moreover, current to the coil assembly 902 can be applied in each of the three electrical phases BAC to control the movement of the motor for each of magnet arrays 904-906. In this case, the coil assembly 902 has coil arms that respond to the following three-phase power sequence A_BA′CB′AC′BA′CB′_C′.

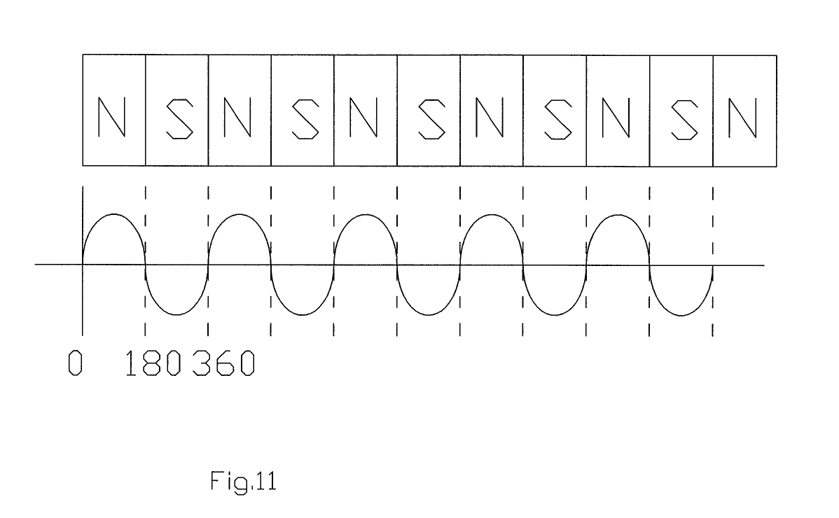

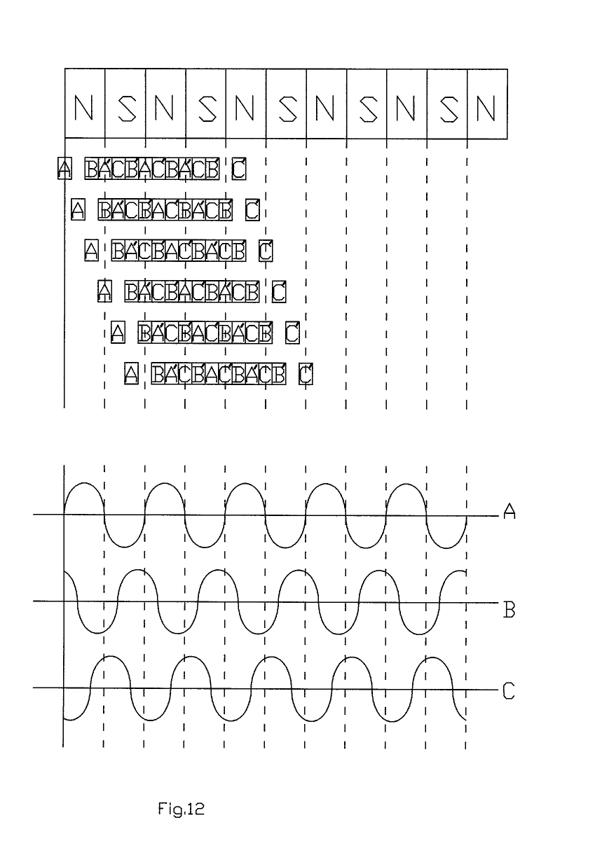

FIG. 11 shows the magnetic flux being applied to the coil assembly 902, and FIG. 12 shows the resulting movement. Referring now to FIG. 12, an exemplary movement for the motor 900 is illustrated. The motor 900 has an array of 12 coil arms responsive to the following sequence A_BA′CB′AC′BA′CB′_C′. First, during period a, the current for phase A is zero and the magnetic flux flows from north (N) to south (S). Since the current is zero, the arm responsive to phase A contributes no net effect on the motor. Turning now to B phase, the current for B is positive and the magnetic flux flows from north (N) to south (S). The Lorentz force induces the B arm coil to move to the right as driven by the B phase power. Turning now to the coil arm that responds to the C phase power, the current for C is negative and the magnetic flux flows from S to N. Lorentz force would also induce the coil move to the right. Hence, the net effect is that the motor 900 is induced to move to the right. This process is repeated for five additional cycles b-f, with the result that the motor moves forward for each cycle at time f. Although the example of FIG. 12 shows forward movement, the motor 900 is free to move forward, backward or remain idle.

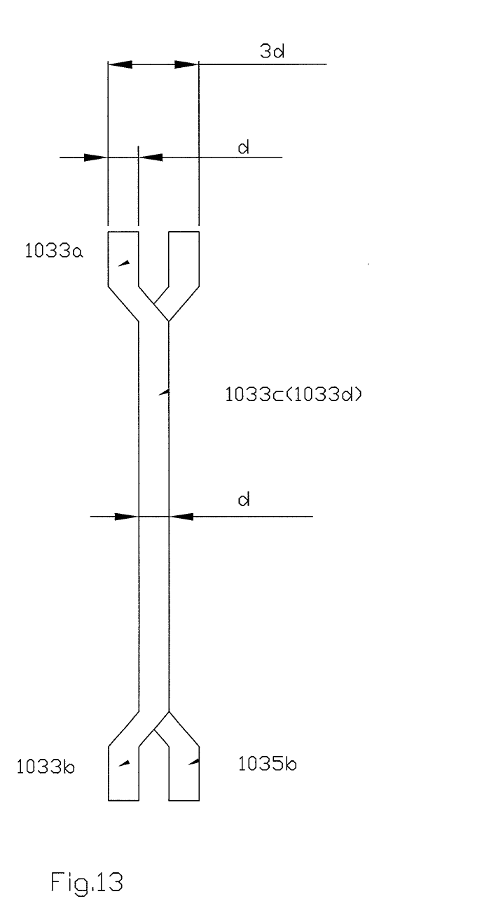

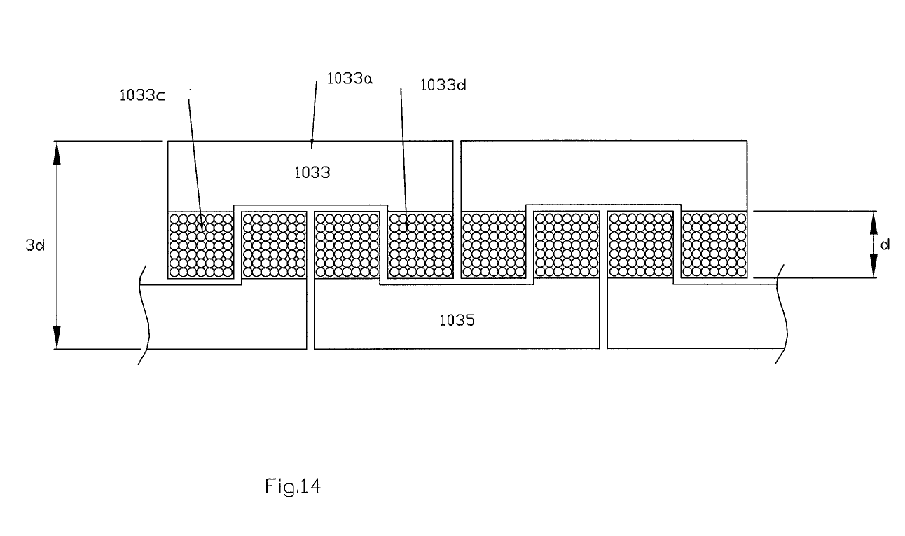

FIG. 13 shows one embodiment of a linear motor 1000 with a gap between engaging coils 1033 and 1035. The coil 1033 has a top arm 1033a and a bottom arm 1033b, and correspondingly the coil 1035 has a top arm 1035a and a bottom arm 1035b. Instead of being tightly engaged with each other, the top arms 1033a and 1035a are separated by one coil width. Similarly, the bottom arms 1033b and 1035b are separated by one coil width, with the result is that the combined coils 1033 and 1035 have a single coil thickness at the center but have a three coil thickness at its ends. FIG. 14 shows a cross-sectional view of the coil windings of the motor 1000. As before, the coil winding is a 7×7 array of wire loops.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A multi-phase coil assembly, comprising:
a first coil having first top and bottom arms on a first plane and a first coil central portion including left and right arms on a second plane;
a second coil having second top and bottom arms on said first plane and a second coil central portion including left and right arms on said second plane, said second coil left arm being positioned adjacent said first coil right arm; and
a third coil having third top and bottom arms on a third plane and a third coil central portion including left and right arms on said second plane and positioned between said first coil right arm and said second coil left arm, said third top arm engaging said first and second top arms and said third bottom arm engaging said first and second bottom arms;
said first, second and third coils being arranged for movement with said central portions on the second plane having a thickness equivalent to a thickness of a single coil and said top and bottom arms each when engaged having a constant thickness of about twice said thickness.

2. The multiphase coil assembly of claim 1, wherein each of said coils is gull-wing shaped.

3. The multiphase coil assembly of claim 1, wherein each of said coils is doubly folded.

4. The multiphase coil assembly of claim 1, wherein each of said coils has a forty-five degree bend connecting each said left and right arms to each said top and bottom arms.

5. The multiphase coil assembly of claim 1, wherein said first plane is spaced from said second plane by one-half said thickness.

6. The multiphase coil assembly of claim 1, wherein said coils being arranged for movement in a gap in the longitudinal direction of a magnetic field.

7. The multiphase coil assembly of claim 1, further comprising additional coils coupled to said first coil with adjacent coils having a thickness equivalent to said thickness.

8. The multiphase coil assembly of claim 1, further comprising:
a fourth coil having fourth top and bottom arms on said first plane and a fourth coil central portion including left and right arms on said second plane;
a fifth coil having second top and bottom arms on said second plane and a fifth coil central portion including left and right arms on said second plane, said fifth coil left arm being positioned adjacent said third coil right arm; and
said first, second, third, fourth and fifth coils being arranged for movement with said central portions having a thickness equivalent to a thickness of a single coil and said top and bottom arms each when engaged having a thickness equivalent to twice said thickness.

9. The multiphase coil assembly of claim 1, further comprising a yoke having a first slot to receive said coil assembly and a second slot capable of receiving a second coil assembly.

10. The multiphase coil assembly of claim 9, wherein each slot comprises two opposing faces, wherein each opposing face further includes a plurality of magnets aligned in a row forming a magnet plane and having a longitudinal axis, said magnets aligned with alternating pole orientations on the faces of said magnet plane.

11. A linear motor yoke assembly, comprising:
first and second coil assemblies, each coil assembly formed from a plurality of coils; and
a housing with two substantially elongated slots adapted to receive said first and second coil assemblies, wherein each elongated slot includes two opposing faces, wherein each opposing face including a plurality of magnets aligned in a row and having a longitudinal axis, said magnets aligned with alternating pole orientations on the faces of said magnet plane.

12. The linear motor yoke assembly of claim 11, further comprising a magnetic flux line traversing said magnets on said first and second slots in a single loop.

13. The linear motor yoke assembly of claim 11, wherein each coil assembly further comprises:
a first coil having first top and bottom arms on a first plane and a first coil central portion including left and right arms on a second plane;
a second coil having second top and bottom arms on said first plane and a second coil central portion including left and right arms on said second plane, said second coil left arm being positioned adjacent said first coil right arm; and
a third coil having third top and bottom arms on a third plane and a third coil central portion including left and right arms on said second plane and positioned between said first coil right arm and said second coil left arm, said third top arm engaging said first and second top arms and said third bottom arm engaging said first and second bottom arms;
said first, second and third coils being arranged for movement with said central portions on the second plane having a thickness equivalent to a thickness of a single coil and said top and bottom arms each when engaged having a constant thickness of about twice said thickness.

14. The linear motor yoke assembly of claim 11, wherein said two slots includes at least eight magnets and wherein said magnetic flux path traverses through eight magnets in said single loop.

15. The linear motor yoke assembly of claim 11, wherein said housing is M-shaped.

16. The linear motor yoke assembly of claim 11, wherein each coil assembly includes a central portion with a thickness equivalent to a thickness of a single coil, each coil assembly having top and bottom portions having a thickness equivalent to twice said thickness.

17. A linear motor, comprising:
first and second coil assemblies, each coil assembly including:
a first coil having first top and bottom arms on a first plane and a first coil central portion including left and right arms on a second plane;
a second coil having second top and bottom arms on said first plane and a second coil central portion including left and right arms on said second plane, said second coil left arm being positioned adjacent said first coil right arm; and
a third coil having third top and bottom arms on a third plane and a third coil central portion including left and right arms on said second plane and positioned between said first coil right arm and said second coil left arm, said third top arm engaging said first and second top arms and said third bottom arm engaging said first and second bottom arms;
said first, second and third coils being arranged for movement with said central portions on the second plane having a thickness equivalent to a thickness of a single coil and said top and bottom arms each when engaged having a constant thickness of about twice said thickness; and
a housing with two substantially elongated slots adapted to receive said first and second coil assemblies, wherein each elongated slot includes two opposing faces, wherein each opposing face including a plurality of magnets aligned in a row and having a longitudinal axis, said magnets aligned with alternating pole orientations on the faces of said magnet plane.
